(19) United States
(12) Patent Application Publication
(10) Pub. No.: US 2011/0141748 A1
(43) Pub. Date: Jun. 16, 2011

(54) LED bracket weld-free plug-in lamp

(76) Inventor: Han-Ming Lee, Hsinchu City (TW)

(21) Appl. No.: 12/653,338

(22) Filed: Dec. 14, 2009

(51) Int. Cl. F21V 21/00

(52) U.S. Cl. 362/363

(57) ABSTRACT

The present invention relates to a LED bracket weld-free plug-in lamp, comprising the lamp cover, lamp seat, circuit board, two conducting brackets, chips, conducting wires, transparent adhesive tapes and copper heads, wherein a cross ring groove is provided at the center of the lamp seat for embedding and fastening of the circuit board so that the two conducting brackets are pressed in and inserted and the positive and negative plates on the two sides of the circuit board press tightly into one to stabilize the conducting effect, prevent the quality of chips from being undermined due to traditional direct solder fusion and significantly extend the service life of the LED chips.

### BACKGROUND OF THE INVENTION

In recent years, the power-saving LED lamps have replaced the traditional tungsten filament bulbs and been widely used in a wide variety of electronic products. The lighting principle is that chips are built inside the chip cup above the bracket and a circuit board is welded below the bracket to input power and generate the trigger light source. The effect of serious high heat accumulated due to being energized for a long time results in premature optical decay of the chips and shortened service life. In particular, the welded circuit board of the chip cup bracket needs to be fully fused with solder at high temperature so that the bracket and circuit board are welded firmly together; during the process of fusing with solder at high temperatures, the heat is transferred along the bracket to the chips above the bracket within a very short period of time, therefore significantly shortening the service life of the chips being heated directly.

### SUMMARY OF THE INVENTION

The primary purpose of the present invention is to provide a LED bracket weld-free plug-in lamp and in particular to one comprising the lamp cover, lamp seat, circuit board, two conducting brackets, chips, conducting wires, transparent adhesive tapes and copper heads to prevent the quality of chips from being undermined due to traditional direct solder fusion and significantly extend the service life of the LED chips.

The secondary purpose of the present invention is to provide a LED bracket weld-free plug-in bracket and in particular to one in which a cross ring groove is provided at the center of the lamp seat so that the circuit board may be embedded and fastened into the groove, and the two conducting brackets are pressed into the fastening device in a crossed manner, and the positive and negative plates on the two sides of the circuit board press tightly into one to stabilize the conducting effect.

Another purpose of the present invention is to provide a LED bracket weld-free plug-in lamp and in particular to one in which the ring groove is provided for embedding and fastening of the circuit board and two fastening supports in a crossed manner, therefore preventing the heat from traditional direct solder fusion being transferred to the chips and decreasing the efficiency of LED.

Another purpose of the present invention is to provide a LED bracket weld-free plug-in lamp, wherein the lamp seat and lamp cover are provided with a plurality of radiating holes for convective diffusion of the heat inside the lamp and decreasing the temperature, therefore achieving the industrial application of decreasing the accumulation of heat and reducing the optical decay of the known enclosed structure.

### BRIEF DESCRIPTION OF THE DRAWINGS

FIG. 1 is a 3D diagram of the present invention.

FIG. 2 is a schematic diagram of the components of the present invention.

FIG. 3 is a cross-section 3D diagram of the present invention.

FIG. 4 is a schematic of the circuit board and conducting brackets embedded and fastened into the ring groove of the present invention to stabilize the conducting function.

FIG. 5 is a schematic of the conducting brackets pressed into the ring groove of the present invention.

FIG. 6 is a schematic of the lighting function of the chips of the present invention.

FIG. 7 is a schematic of another embodiment of the two LEDs of the present invention.

FIG. 8 is a schematic of another embodiment of the three LEDs of the present invention.

FIG. 9 is a schematic of another embodiment of the four LEDs of the present invention.

FIG. 10 is a schematic of another embodiment of the integrated lamp cover of the present invention.

FIG. 11 is a schematic of another embodiment of the present invention.

### DETAILED DESCRIPTION OF THE PREFERRED EMBODIMENT

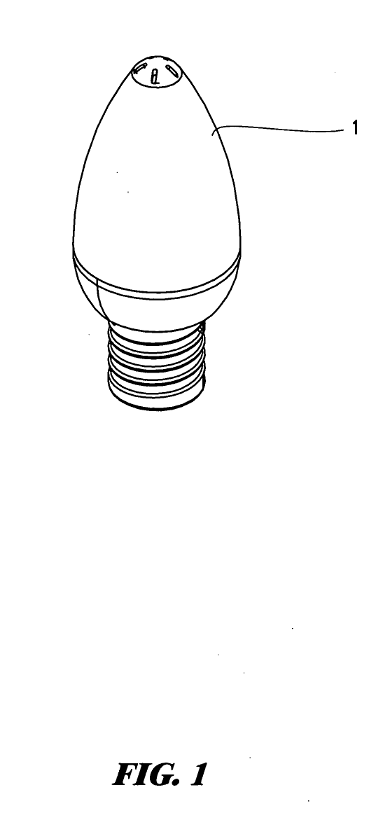

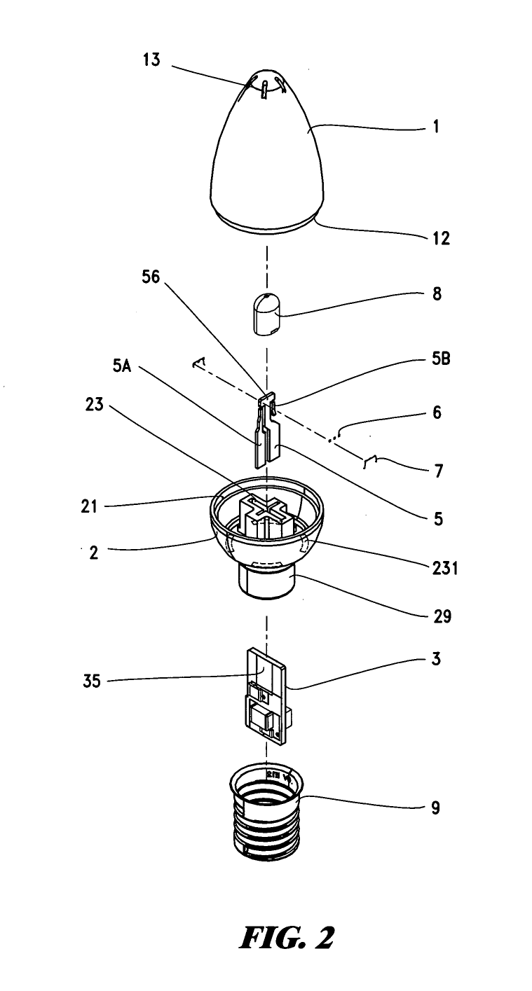

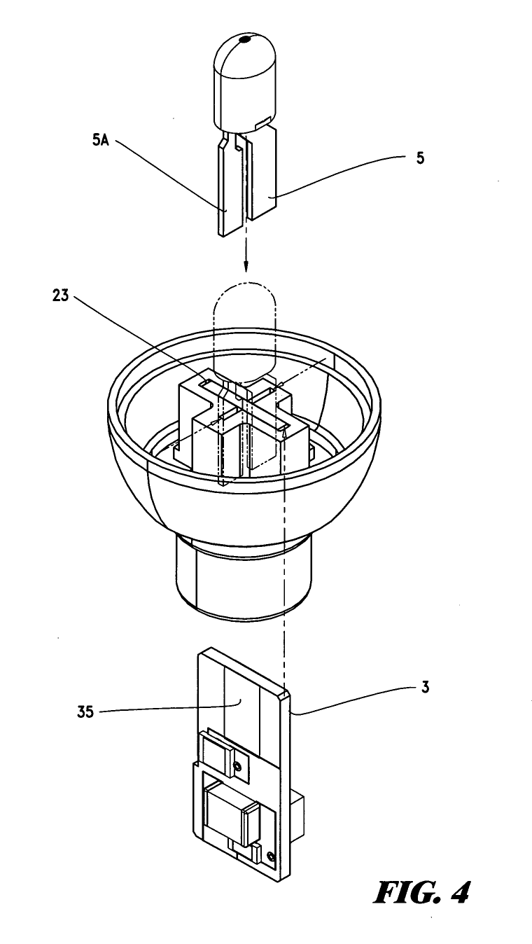

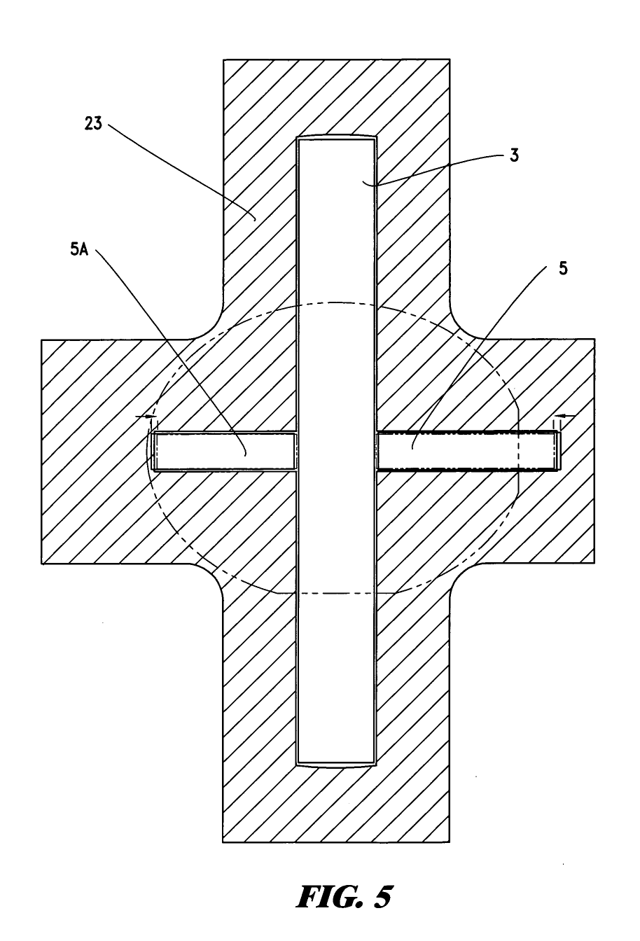

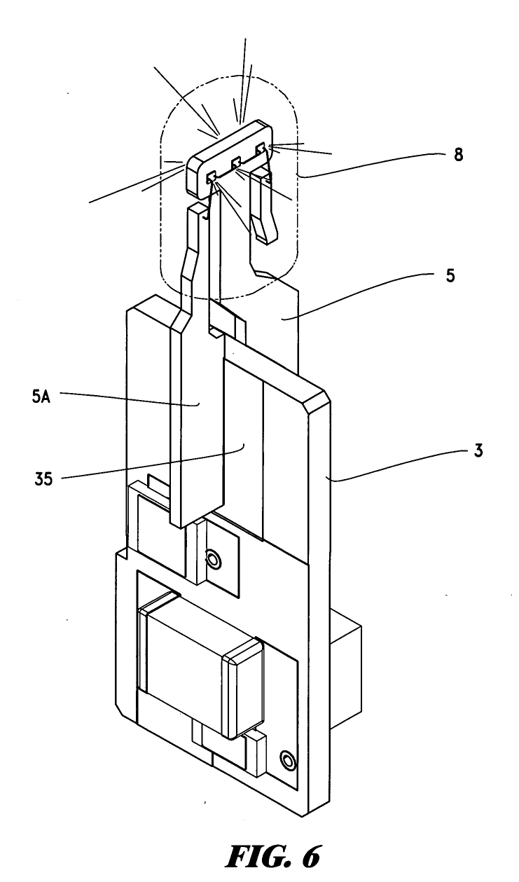

Please refer to FIGS. 1 through FIGS. 6. The present invention relates to a LED bracket weld-free plug-in lamp, comprising the lamp cover 1, lamp seat 2, circuit board 3, two conducting brackets 5 and 5A, chip 6, conducting wire 7, transparent adhesive tap 8 and copper head 9; the lamp cover 1 is an open thin cover made of light-transmitting material, the opening is provided with lower ring diameter or thread 12, and its sealing is provided with equally spaced radiating holes 13; the lamp seat 2 is a lamp seat made of light-transmitting material in relative to the opening of the lamp cover 1, the opening of the lamp seat is provided with expanded ring diameter or thread 21 for embedding or screwing into place of the lower ring diameter or thread 12 of the lamp cover, the center of the lamp is provided with cross ring groove 23, the outer ring of the cross ring groove is provided with a plurality of radiating holes 231 at the lamp seat, and a snap ring 29 projects downward from the center of the bottom of the lamp seat; the circuit board 3 is a LED lamp conducting control circuit board, a plurality of positive and negative plates 35 are provided on the two sides above the circuit board for embedding upward into the cross ring groove 23 for fastening directly from the bottom of the lamp seat 2; the two conducting brackets 5 and 5A are two expanded transverse trapezoidal blocks 56 on the two wings above one conducting bracket 5, the bottom of the two wings is provided for another conducting bracket 5A and a bridging plate 5B, and the bottom of the two conducting brackets 5 and 5A is inserted into the cross ring groove 23 and the positive and negative plates 35 on the two sides of the circuit board 3 press tightly against each other for conducting; the chip 6 is a lighting semi-conductor chip for insertion into the two sides of the transverse trapezoidal block 56; the conducting wire 7 is a wire made of conducting material with its two ends connecting the plurality of chips 6, two conducting brackets 5 and 5A and bridging plate 5B, and the bridging plate is provided for connection of the front and back chips in series; the transparent adhesive tape 8 is a resin or silicon light-transmitting material injection sealing the two conducting brackets 5 and 5A, the plurality of chips 6 on the bridging plate 5B and the plurality of conducting wires 7 into one; the copper head 9 is the screw-type conducting joint of the traditional bulb for fastening the snap ring 29 below the lamp seat.

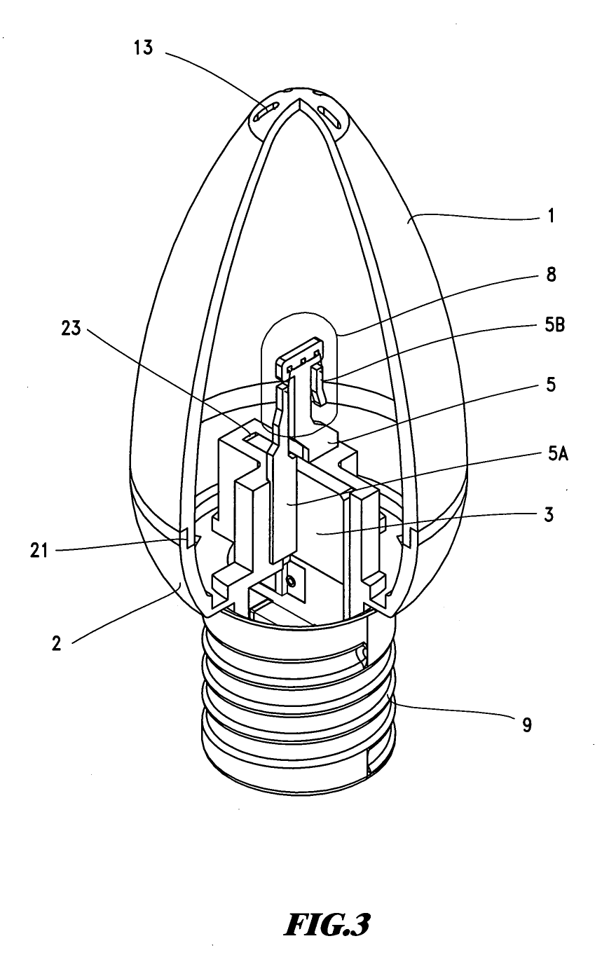

Please refer to FIGS. 3 through FIGS. 6 for the embodiment of this invention. The center of the lamp seat is provided with a cross ring groove 23 for upward embedding and fastening of the circuit board 3, the two conducting brackets 5 and 5A are embedded and the positive and negative plates 35 on the two sides of the circuit board press tightly into one to stabilize the conducting effect, therefore preventing the quality of chips from being undermined due to traditional direct solder fusion and improving the service life of the LED chips significantly. Moreover, a plurality of radiating holes 13 and 231 are provided on the lamp seat and lamp cover for convective diffusion of the heat inside the lamp and decreasing the temperature, therefore achieving the industrial application of decreasing the accumulation of heat and reducing the optical decay of the known enclosed structure.

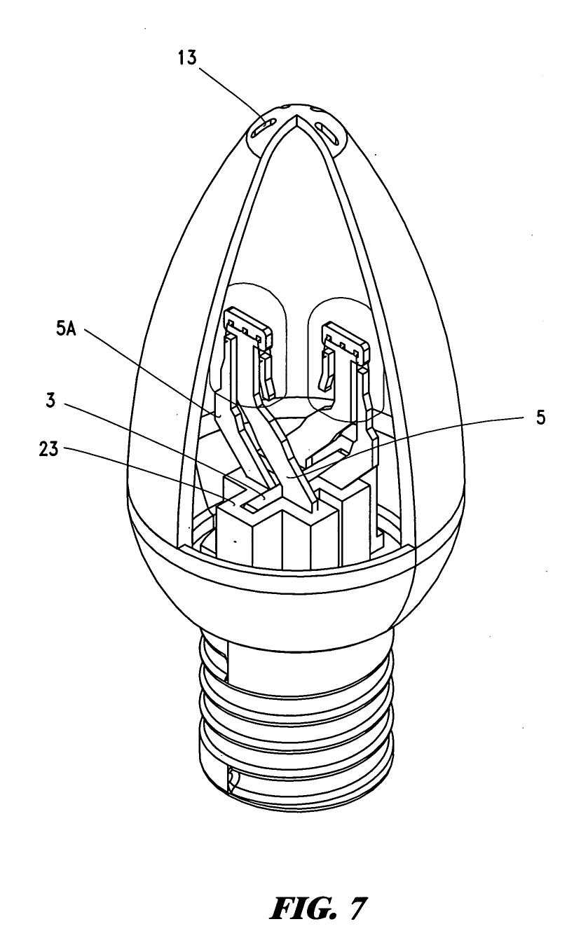

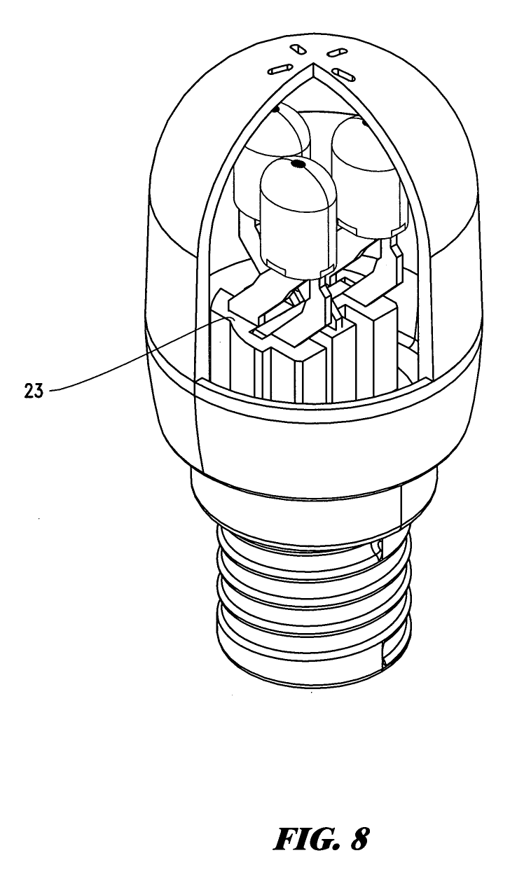

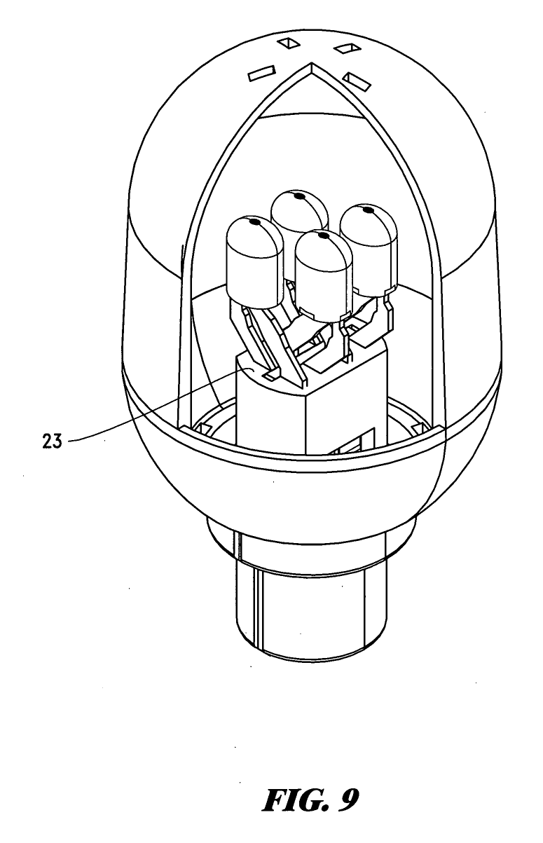

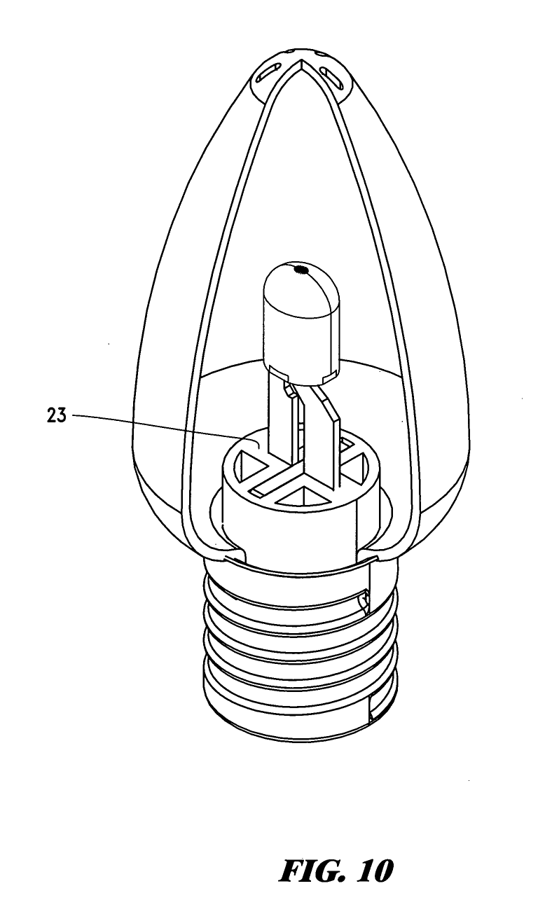

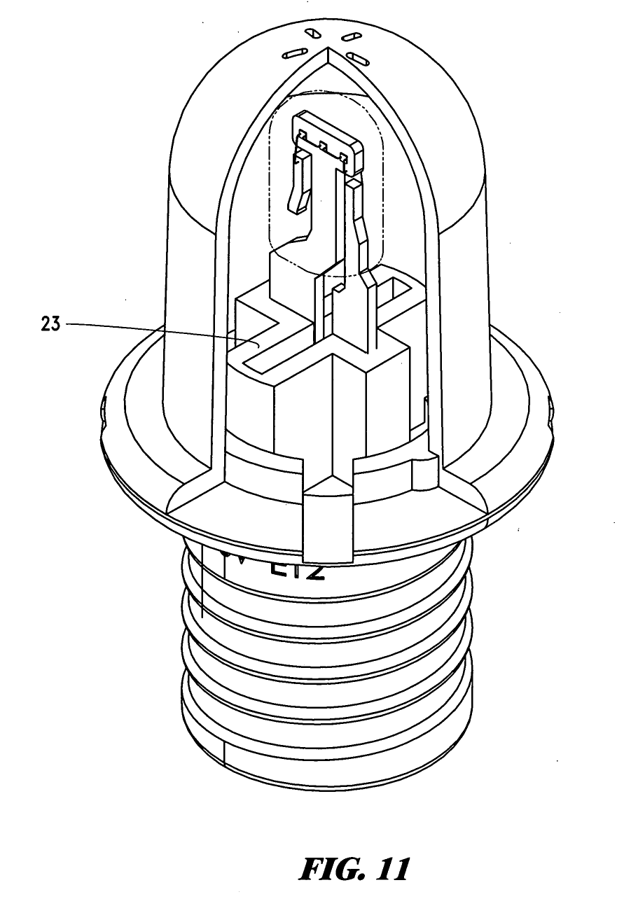

Please refer to FIGS. 7 through FIGS. 11 for another embodiment of the present invention. The ring groove at the center of the lamp seat 2 may be a plurality of cross-type connected ring grooves 23, the brackets 5 and 5A below the LED lamp are embedded and inserted into the ring groove in a staggered manner, and the positive and negative plates 35 on the two sides of the circuit board press tightly into one to stabilize the conducting effect so that the variant combinations of more than one LED lamp can be achieved in the lamp cover.

I claim:

1. A LED bracket weld-free plug-in lamp, comprising the lamp cover, lamp seat, circuit board, two conducting brackets, chips, conducting wires, transparent adhesive tapes and copper heads, wherein, the lamp cover is an open thin cover made of light-transmitting material, the opening is provided with lower ring diameter or thread, and its sealing is provided with equally spaced radiating holes; the lamp seat is a lamp seat made of light-transmitting material in relative to the opening of the lamp cover, the opening of the lamp seat is provided with expanded ring diameter or thread for embedding or screwing into place of the lower ring diameter or thread of the lamp cover, the center of the lamp is provided with cross ring groove, the outer ring of the cross ring groove is provided with a plurality of radiating holes at the lamp seat, and a snap ring projects downward from the center of the bottom of the lamp seat; the circuit board is a LED lamp conducting control circuit board, a plurality of positive and negative plates are provided on the two sides above the circuit board for embedding upward into the cross ring groove for fastening directly from the bottom of the lamp seat; the two conducting brackets are two expanded transverse trapezoidal blocks on the two wings above one conducting bracket, the bottom of the two wings is provided for another conducting bracket and a bridging plate, and the bottom of the two conducting brackets is inserted into the cross ring groove and the positive and negative plates on the two sides of the circuit board press tightly against each other for conducting; the chip is a lighting semi-conductor chip for insertion into the two sides of the transverse trapezoidal block; the conducting wire is a wire made of conducting material with its two ends connecting the plurality of chips, two conducting brackets and bridging plate, and the bridging plate is provided for connection of the front and back chips in series; the transparent adhesive tape is a resin or silicon light-transmitting material injection sealing the two conducting brackets the plurality of chips on the bridging plate and the plurality of conducting wires into one; the copper head is the screw-type conducting joint of the traditional bulb for fastening the snap ring below the lamp seat; The center of the lamp seat is provided with a cross ring groove for upward embedding and fastening of the circuit board, the two conducting brackets are embedded and the positive and negative plates on the two sides of the circuit board press tightly into one to stabilize the conducting effect, therefore preventing the quality of chips from being undermined due to traditional direct solder fusion and improving the service life of the LED chips significantly.

2. The LED bracket weld-free plug-in lamp according to claim 1, wherein the plurality of radiating holes and are provided on the lamp seat and lamp cover for convective diffusion of the heat inside the lamp and decreasing the temperature.

3. The LED bracket weld-free plug-in lamp according to claim 1, wherein the ring groove at the center of the lamp seat may be a plurality of cross-type connected ring grooves, the brackets and below the LED lamp are embedded and inserted into the ring groove in a staggered manner, so that the variant combinations of more than one LED lamp can be achieved in the lamp cover.
